(19) United States
(12) Patent Application Publication
(10) Pub. No.: US 2026/0239259 A1
(43) Pub. Date: Aug. 13, 2026

(54) PUBLIC WARNING SYSTEM OVER WIRELESS LOCAL AREA NETWORK

(71) Applicant: QUALCOMM Incorporated, San Diego, CA (US)

(72) Inventors: Amer CATOVIC, San Diego, CA (US); Haris ZISIMOPOULOS, London (GB); Masato KITAZOE, Hachiouji-shi (JP); Masakazu SHIROTA, Yokohama-shi (JP); Shigeyuki KOBAYASHI, Yokohama-shi (JP); Lenaig Genevieve CHAPONNIERE, La Jolla, CA (US)

(21) Appl. No.: 19/161,194

(22) PCT Filed: Mar. 26, 2024
(86) PCT No.: PCT/US2024/021466

§ 371 Date: Aug. 29, 2025

(30) Foreign Application Priority Data
May 4, 2023 (GR) 20230100363

(51) Int. Cl. H04W 60/00; H04W 4/90; H04W 88/06

(52) U.S. Cl. CPC H04W 60/005; H04W 4/90; H04W 88/06

(57) ABSTRACT

A wireless communication device performs a registration procedure with a public land mobile network (PLMN) via a wireless local area network (WLAN). The wireless communication device obtains PLMN services, including at least a public warning service, over the WLAN subsequent to performing the registration procedure. The wireless communication device receives a public warning service notification via the public warning service and retrieves public warning service information from the PLMN via the WLAN in response to receiving the public warning service notification. An access point to a core network of a wireless communication network receives emergency information associated with a public warning service and transmits the emergency information to one or more wireless communication devices registered with the wireless communication network via a wireless local area network (WLAN).

### CROSS-REFERENCE TO RELATED APPLICATIONS

The present Application for Patent claims priority to pending Greece Application no. 20230100363, filed May 4, 2023, and assigned to the assignee hereof and hereby expressly incorporated by reference herein as if fully set forth below and for all applicable purposes.

### TECHNICAL FIELD

This disclosure relates generally to wireless communication, and more specifically, to access to a Public Warning System (PWS) over a wireless local area network.

### INTRODUCTION

A wireless local area network (WLAN) may be formed by one or more wireless access points (APs) that provide a shared wireless communication medium for use by multiple client devices also referred to as wireless stations (STAs) and user equipment (UEs) herein. The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN. Broadcast services are not available via a WLAN.

A Public Warning System (PWS) is standardized in systems operating under standards promulgated by the 3rd Generation Partnership Project (3GPP), such as Long Term Evolution (LTE), 3G, 4G, and 5G (New Radio (NR)). Presently, the WLAN conforming to the IEEE 802.11 family of standards does not support a public warning system such as the PWS found in the 3GPP family of standards. Although 3GPP coverage is becoming ubiquitous, there are many locations that lack 3GPP coverage. One example may be a high rise residential or business building, whose upper floors may not be illuminated by beams associated with 3GPP wireless communication towers. A user that lives or visits an area that does not receive 3GPP coverage may be deprived of the benefit of the PWS because the user's UE cannot connect to the 3GPP network and therefore cannot receive alerts broadcast over the PWS. However, although a UE may be in a 3GPP dead zone, there is a probability that the same UE might be within range of a WLAN covered by a wireless AP.

### BRIEF SUMMARY OF SOME EXAMPLES

The systems, methods, and devices of this disclosure each have several innovative aspects, no single one of which is solely responsible for the desirable attributes disclosed herein.

In one example, a method operational at a wireless communication device is disclosed. The method includes performing a registration procedure with a public land mobile network (PLMN) via a wireless local area network (WLAN), obtaining PLMN services over the WLAN subsequent to performing the registration procedure, the PLMN services including at least a public warning service, receiving a public warning service notification via the public warning service, and retrieving public warning service information from the PLMN via the WLAN in response to receiving the public warning service notification.

In another example wireless communication device is disclosed. The wireless communication device includes one or more memories and one or more processors. The one or more processors being configured to, based at least in part on information stored in the one or memories: perform a registration procedure with a public land mobile network (PLMN) via a wireless local area network (WLAN), obtain PLMN services over the WLAN subsequent to performing the registration procedure, the PLMN services including at least a public warning service, receive a public warning service notification via the public warning service, and retrieve public warning service information from the PLMN via the WLAN in response to receiving the public warning service notification.

In one example, a method operational at an access point to a core network of a wireless communication network is disclosed. The method includes receiving emergency information associated with a public warning service and transmitting the emergency information to one or more wireless communication devices registered with the wireless communication network via a wireless local area network (WLAN).

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a schematic illustration of an example of a wireless communication network according to some aspects of the disclosure.

FIG. 2 is a schematic illustration of an example of a radio access network according to some aspects of the disclosure.

FIG. 3 is a schematic illustration of an example of a disaggregated base station architecture according to some aspects of the disclosure.

FIG. 4 is an expanded view of an exemplary subframe, showing an orthogonal frequency divisional multiplexing (OFDM) resource grid according to some aspects of the disclosure.

FIG. 5 is a high-level block diagram illustrating coverage of a Public Warning System according to some aspects of the disclosure.

FIG. 6 depicts a network structure of a legacy 5GS PWS architecture using a reference point representation showing how network functions interact with each other when a PWS-interworking function (PWS-IWF) is used according to some aspects of the disclosure.

FIG. 7 is a call flow diagram illustrating how the network structure of the legacy 5GS PWS architecture of FIG. 6 may operate in 3GPP according to some aspects of the disclosure.

FIG. 8 depicts a network structure of a 5GS PWS architecture using a reference point representation showing how network functions interact with each other when a PWS-IWF and access and mobility management function that support PWS over WLAN are used according to some aspects of the disclosure.

FIG. 9 is a call flow diagram that illustrates how the network structure of the 5GS PWS architecture of FIG. 8 may operate in a 3GPP system to provide PWS over WLAN according to some aspects of the disclosure.

FIG. 10 is a block diagram illustrating an example of a hardware implementation of a wireless communication device employing a processing system according to some aspects of the disclosure.

FIG. 11 is a flow chart illustrating an example process of wireless communication at a wireless communication device in accordance with some aspects of the disclosure.

FIG. 12 is a block diagram illustrating an example of a hardware implementation of an access point to a core network employing a processing system according to some aspects of the disclosure.

FIG. 13 is a flow chart illustrating an example process of wireless communication at an access point to a core network according to some aspects of the disclosure.

FIG. 14 is a block diagram representation of protocol stacks of a wireless communication device, a Trusted Non-3GPP Access Point, a Trusted Non-3GPP Gateway Function, and an access and mobility management function implementing PWS over WLAN according to some aspects of the disclosure.

Like reference numbers and designations in the various drawings indicate like elements.

### DETAILED DESCRIPTION

The detailed description set forth below in connection with the appended drawings is directed to some particular examples for the purpose of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Additionally, the detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to the person having ordinary skill in the art that these concepts may be practiced without these specific details. In some examples, well known structures and components are shown in block diagram form in order to avoid obscuring such concepts.

While aspects and examples are described in this application by illustration to some examples, a person having ordinary skill in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Various aspects relate generally to wireless communication and more particularly to the provision of 3GPP Public Warning System (PWS) services to user equipment over a non-3GPP system (e.g., over wireless local area network (WLAN)). As described herein, a PWS is a mechanism to distribute warning notifications over 3GPP systems, including timely and accurate alerts, warnings and critical information regarding disasters and other emergencies, such as earthquakes, tsunamis, hurricanes, and wildfires. Based on the preceding discussion, PWS may be understood as an umbrella term that encompasses several features that comply with respective national regulations about warning notifications over cellular systems around the world. Implementation of PWS over WLAN may increase the availability of the beneficial warnings provided by PWS to UEs that have either temporarily lost connection to a 3GPP network or are located in an area which does not have 3GPP network coverage. A warning notification may typically include one or more of the following elements: Event Description, Area Affected, Recommended Action, Expiration Time, Sending Agency. A warning notification may be delivered in two steps: a brief “primary notification,” followed by a “secondary notification” with more details (e.g., actions to take). The various concepts presented throughout this disclosure may be implemented across a broad variety of telecommunication systems, network architectures, and communication standards.

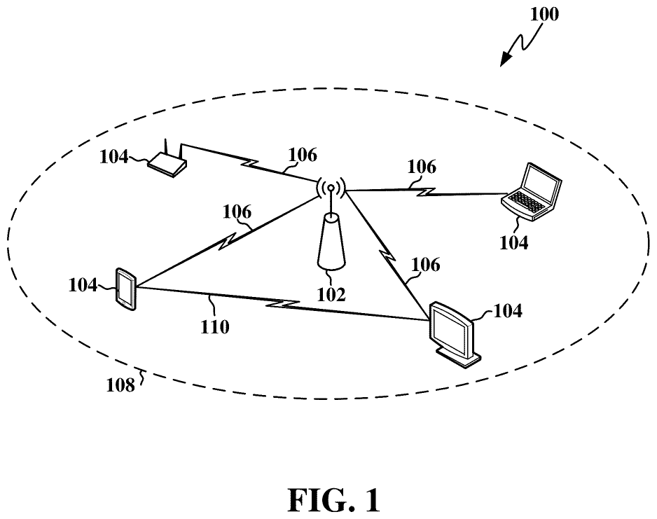

FIG. 1 is a schematic illustration of an example of a wireless communication network 100 according to some aspects of the disclosure. According to some aspects, the wireless communication network 100 can be an example of a wireless local area network (WLAN) such as a Wi-Fi® network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, Chromebooks®, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IOT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHZ, or 60 GHz bands). To perform passive scanning, a station (STA) 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHZ, or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

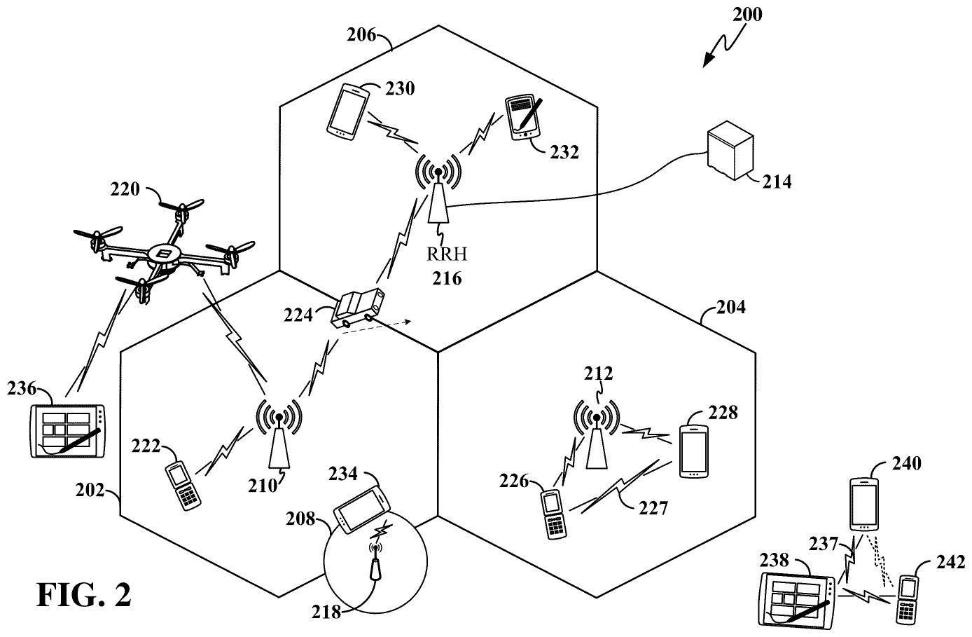

FIG. 2 is a schematic illustration of an example of a radio access network (RAN) 200 according to some aspects of the disclosure. The RAN 200 may implement any suitable wireless communication technology or technologies to provide radio access. As one example, the RAN 200 may operate according to 3GPP New Radio (NR) specifications, often referred to as 5G. As another example, the RAN 200 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 200 may be divided into a number of cellular regions (cells) that can be uniquely identified by a user equipment (UE) (e.g., a wireless communication device) based on an identification broadcasted over a geographical area from one network entity (e.g., an access point, a base station). FIG. 2 illustrates cells 202, 204, 206, and 208, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is a network element in a radio access network responsible for radio transmission and reception in one or more cells to or from a UE. A network entity may also be referred to by a person having ordinary skill in the art as a base station (BS), base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a network entity may include two or more TRPs that may be collocated or non-collocated. Each TRP may communicate on the same or different carrier frequency within the same or different frequency band. In examples where the RAN 200 operates according to both the LTE and 5G NR standards, one of the TRPs may be an LTE base station, while another TRP may be a 5G NR base station. In some examples, a network entity may be configured in an aggregated or monolithic base station architecture or in a disaggregated base station architecture.

Various network entity (e.g., base station) arrangements can be utilized. For example, in FIG. 2, two network entities 210 and 212 are shown in cells 202 and 204; and a third network entity 214 is shown controlling a remote radio head (RRH) 216 in cell 206. That is, a network entity can have an integrated antenna or can be connected to an antenna or RRH by feeder cables. In the illustrated example, the cells 202, 204, and 206 may be referred to as macrocells, as the network entities 210, 212, and 214 support cells having a large size. Further, a network entity 218 is shown in the cell 208 which may overlap with one or more macrocells. In this example, the cell 208 may be referred to as a small cell (e.g., a microcell, picocell, femtocell, home base station, home Node B, home eNode B, etc.), as the network entity 218 supports a cell having a relatively small size. Cell sizing can be done according to system design as well as component constraints.

It is to be understood that the radio access network 200 may include any number of wireless network entities (e.g., base stations) and cells. Further, a relay node may be deployed to extend the size or coverage area of a given cell. The network entities 210, 212, 214, 218 provide wireless access points to a core network for any number of mobile apparatuses.

FIG. 2 further includes an unmanned aerial vehicle (UAV) 220, which may be a drone (e.g., a quadcopter, and octocopter, etc.). The UAV 220 may be configured to function as a network entity, or more specifically as a mobile network entity. That is, in some examples, a cell may not necessarily be stationary, and the geographic area of the cell may move according to the location of a mobile network entity such as the UAV 220.

In general, network entities may include a backhaul interface for communication with a backhaul portion (not shown) of the network. The backhaul may provide a link between a network entity and a core network (not shown), and in some examples, the backhaul may provide interconnection between the respective network entities. The core network may be a part of a wireless communication system and may be independent of the radio access technology used in the radio access network. Various types of backhaul interfaces may be employed, such as a direct physical connection, a virtual network, or the like using any suitable transport network.

The RAN 200 is illustrated supporting wireless communication for multiple mobile apparatuses. A mobile apparatus is commonly referred to as a user equipment (UE) in standards and specifications promulgated by the 3GPP, but may also be referred to by a person having ordinary skill in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 200, the cells may include UEs that may be in communication with one or more sectors of each cell. For example, UEs 222 and 224 may be in communication with network entity 210; UEs 226 and 228 may be in communication with network entity 212; UEs 230 and 232 may be in communication with network entity 214 by way of RRH 216; UE 234 may be in communication with network entities 218; and UE 236 may be in communication with mobile network entity 220. Here, each network entity 210, 212, 214, 218, and 220 may be configured to provide an access point to a core network (not shown) for all the UEs in the respective cells. In some examples, the UAV 220 (e.g., the quadcopter) can be a mobile network entity and may be configured to function as a UE. For example, the UAV 220 may operate within cell 202 by communicating with network entity 210.

Wireless communication between a RAN 200 and a UE (e.g., UE 222 or 224) may be described as utilizing an air interface. Transmissions over the air interface from a network entity (e.g., network entity 210) to one or more UEs (e.g., UE 222 and 224) may be referred to as downlink (DL) transmission. In accordance with certain aspects of the present disclosure, the term downlink may refer to a point-to-multipoint transmission originating at a network entity (sometimes referred to as a scheduling entity) (e.g., network entity 210). Another way to describe this scheme may be to use the term broadcast channel multiplexing. Transmissions from a UE (e.g., UE 222) to a network entity (e.g., network entity on 210) may be referred to as uplink (UL) transmissions. In accordance with further aspects of the present disclosure, the term uplink may refer to a point-to-point transmission originating at a UE (sometimes referred to as a scheduled entity) (e.g., UE 222).

For example, DL transmissions may include unicast or broadcast transmissions of control information (control signaling) and/or traffic information (e.g., user data traffic) from a network entity (e.g., network entity 210) to one or more UEs (e.g., UEs 222 and 224), while UL transmissions may include transmissions of control information and/or traffic information originating at a UE (e.g., UE 222). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The air interface in the RAN 200 may utilize one or more multiplexing and multiple access algorithms to enable simultaneous communication of the various devices. For example, 5G NR specifications provide multiple access for UL or reverse link transmissions from UEs 222 and 224 to network entity 210, and for multiplexing DL or forward link transmissions from the network entity 210 to UEs 222 and 224 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 200 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz 7.125 GHz) and FR2 (24.25 GHz-52.6 GHz). It should be understood that although a portion of FR1 is greater than 6 GHz, FR1 is often referred to (interchangeably) as a “Sub- 6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHZ), FR4 (52.6 GHZ 114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a network entity) allocates resources (e.g., time-frequency resources) for communication among some or all devices and equipment (e.g., UEs) within its service area or cell. Within the present disclosure, as discussed further below, the scheduling entity (e.g., the network entity) may be responsible for scheduling, assigning, reconfiguring, and releasing resources for one or more scheduled entities (e.g., UEs). That is, for scheduled communication, scheduled entities utilize resources allocated by the scheduling entity.

Network entities are not the only entities that may function as a scheduling entity. That is, in some examples, a UE may function as a network entity, scheduling resources for one or more other UEs (e.g., one or more other scheduled entities). For example, two or more UEs (e.g., UEs 238, 240, and 242) may communicate with each other using sidelink signals 237 without relaying that communication through a network entity. In some examples, the UEs 238, 240, and 242 may each function as a network entity (e.g., a scheduling entity) or transmitting sidelink device and/or a UE (e.g., a scheduled entity) or a receiving sidelink device to schedule resources and communicate the sidelink signals 237 therebetween without relying on scheduling or control information from a network entity. In other examples, two or more UEs (e.g., UEs 226 and 228) within the coverage area of a network entity (e.g., network entity 212) may also communicate sidelink signals 227 over a direct link (sidelink) without conveying that communication through the network entity 212. In this example, the network entity 212 may allocate resources to the UEs 226 and 228 for the sidelink communication. In either case, such sidelink signals 227 and 237 may be implemented in a peer-to-peer (P2P) network, a device-to-device (D2D) network, a vehicle-to-vehicle (V2V) network, a vehicle-to-everything (V2X) network, a mesh network, or other suitable direct link network.

In some examples, a D2D relay framework may be included within a cellular network to facilitate relaying of communication to/from the network entity 212 via D2D links (e.g., sidelink signals 227 or 237). For example, one or more UEs (e.g., UE 228) within the coverage area of the network entity 212 may operate as relaying UEs to extend the coverage of the network entity 212, improve the transmission reliability to one or more UEs (e.g., UE 226), and/or to allow the network entity to recover from a failed UE link due to, for example, blockage or fading.

Two primary technologies that may be used by V2X networks include dedicated short range communication (DSRC) based on IEEE 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

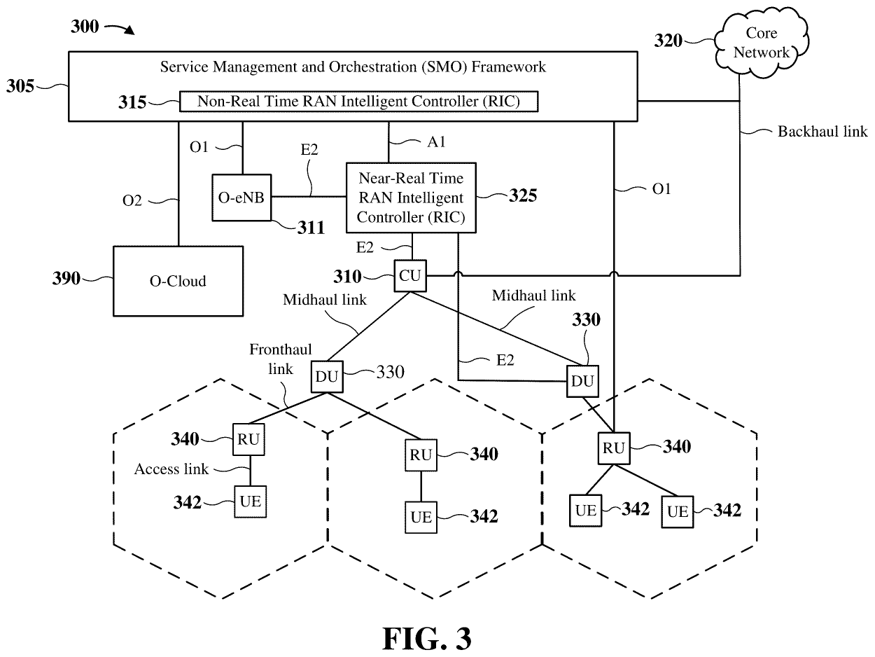

FIG. 3 is a schematic illustration of an example of a disaggregated base station 300 architecture according to some aspects of the disclosure. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more NWs (DUs) 330 via respective midhaul links, such as an F1 interface. The DUs 330 may communicate with one or more radio units (RUs) 340 via respective fronthaul links. The RUs 340 may communicate with respective UEs 342 via one or more radio frequency (RF) access links. In some implementations, the UE 342 may be simultaneously served by multiple RUs 340. UE 342 may be the same or similar to any of the UEs or scheduled entities illustrated and described in connection with FIG. 1 and FIG. 2, for example.

Each of the units, i.e., the CUS 310, the DUs 330, the RUs 340, as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 342. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an Ol interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

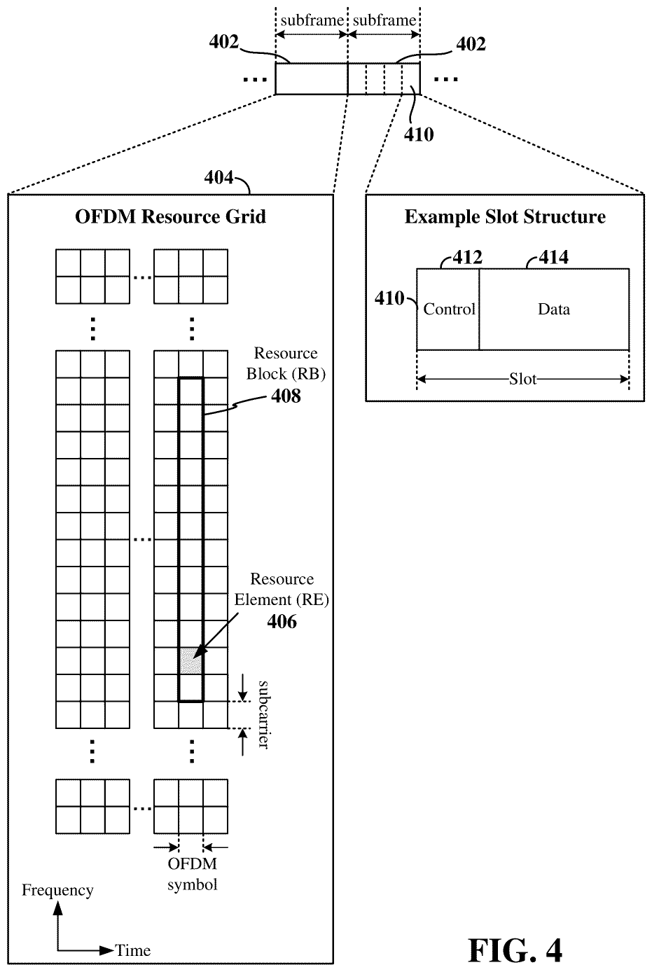

Various aspects of the present disclosure will be described with reference to an OFDM waveform, schematically illustrated in FIG. 4. It should be understood by a person having ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid according to some aspects of the disclosure. However, as a person having ordinary skill in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), subband, or bandwidth part (BWP). A set of subbands or BWPs may span the entire bandwidth. Scheduling of scheduled entities (e.g., UEs) for downlink, uplink, or sidelink transmissions may involve scheduling one or more resource elements 406 within one or more subbands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a network entity (e.g., a base station, a gNB, a TRP, a scheduling entity), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional example may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a network entity) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to a person having ordinary skill in the art, where the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information (e.g., a quantity of the bits of information), may be a controlled parameter, based on the modulation and coding scheme (MCS) and the number of RBs in a given transmission.

The channels or carriers described above in connection with FIGS. 1-4 are not necessarily all of the channels or carriers that may be utilized between a scheduling entity and scheduled entities, and a person having ordinary skill in the art will recognize that other channels or carriers may be utilized in addition to those illustrated, such as other traffic, control, and feedback channels.

A warning system, known as a Public Warning System (PWS) in the United States, distributes alerts to the public via wireless communication devices (e.g., UEs). The alerts may include warnings and critical information regarding disasters and other emergencies, such as earthquakes, tsunamis, hurricanes, and wildfires. The same or similar type of warning systems (referred to as a PWS or some other name) may exist in countries around the world. For example, the European Union has adopted an EU-Alert system and South Korea has adopted a Korean Public Alert System (KPAS). This specification refers to any such public warning type of system as a PWS.

The specifications of the PWS may be standardized. For example, 3GPP Technical Specification (TS) 22.268 provides a set of requirements for the PWS that are established for UEs and service providers. TS 22.268 also covers requirements for the Earthquake and Tsunami Warning System (ETWS) and for the Commercial Mobile Alert System (CMAS) (also known as a Wireless Emergency Alert). As used herein, CMAS may be a PWS that delivers warning notifications provided by warning notification providers to UEs. CMAS defines the following classes of warning notifications: Presidential, Imminent Threat, Public Safety, Child Abduction Emergency, and State/Local wireless emergency alert (WEA) Test. As used herein the ETWS may be a PWS that delivers warning notifications specific to earthquakes and Tsunamis provided by warning notification providers to the UEs which have the capability of receiving Primary and Secondary warning notifications within Notification Areas through the 3GPP network. ETWS requires a primary notification to reach all users within 4 seconds. As used herein, the term PWS encompasses ETWS and CMAS. KPAS and EU-ALERT may have other requirements. Public land mobile network (PLMN) operators that support PWS may be able to support activation of warning notification delivery, cancellation of warning notification delivery, and updating of warning notification delivery, through interaction with warning notification providers.

As used herein a notification area is an area where PWS warning notifications are broadcast. A warning notification may include an event description, an area affected, a recommended action, an expiration time (with time zone), and a sending agency. The notification area may be an area that closely approximates the geographical information provided by a warning notification provider. UEs described herein, such as the UEs as shown and described in connection with FIGS. 1, 2, and/or 3, may be UEs that are capable of receiving warning notifications within notification areas through a 3GPP network.

These UEs may support, for example, a dedicated alerting indication and a display of a warning notification upon receipt of the warning notification. As indicated above, PWS relies on the 3GPP systems. Only UEs that communicate via a 3GPP system are served by the PWS. However, even some UEs that do communicate via a 3GPP system may not be served by PWS. For example, a bandwidth reduced low complexity UE or a UE supporting enhanced discontinuous reception (eDRX) may not support all requirements for PWS, including ETWS, CMAS, EU-Alert and KPAS.

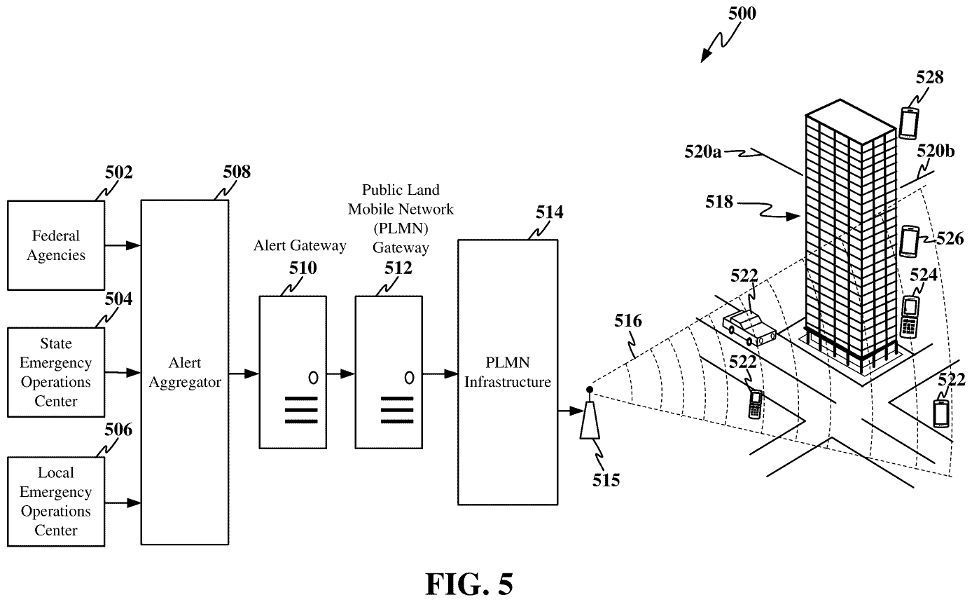

FIG. 5 is a high-level block diagram illustrating coverage of a Public Warning System (PWS) 500 according to some aspects of the disclosure. Certain entities, such as federal agencies 502, state emergency operation centers 504, and local emergency operation centers 506 may transmit (via wireline or wireless) warning notifications to an alert aggregator 508. The alert aggregator may aggregate the warning notifications and transmit (via wireline or wireless) one or more warning notifications to an alert gateway 510. The alert gateway 510 (via wireline or wireless) may transmit the one or more warning notifications to one or more public land mobile network (PLMN) operators via each PLMN operator's PLMN gateway 512. The PLMN operators referred to herein process and transmit warning notifications through the 3GPP network utilizing 3GPP infrastructure (generally referred to herein as PLMN infrastructure). One PLMN gateway 512 is shown to avoid cluttering the drawing. The warning notification may be processed by the PLMN infrastructure 514 of the PLMN operator. The PLMN infrastructure 514 may include, for example, a PWS-IWF, an access point to a core network, such as an access and mobility management function (AMF), a trusted non-3GPP gateway function (TNGF), and a RAN, among other infrastructure.

The warning notification may be wirelessly broadcast 516 from a network entity 515 (e.g., a base station, eNB, gNB, RU) that is either considered a part of the PLMN infrastructure 514 or is associated with the PLMN infrastructure 514. The wireless broadcast 516 of the warning notification is pictorially represented in FIG. 5 by the radiating waves emanating from the network entity 515. Although the arrows depicting communication between the various blocks of FIG. 5, and the direction of propagation of the radiating waves of FIG. 5, flow in one direction, a person having ordinary skill in the art will recognize that communication between the various blocks of FIG. 5 including the network entity 515, and between the network entity 515 and the various UEs of FIG. 5 (including UEs 522, 524, 526) is bidirectional. Single-headed arrows and the curved depiction of the wireless communication in FIG. 5 were used to avoid cluttering the drawing.

As depicted in FIG. 5, the wireless broadcast 516 of the warning notification may not be received throughout a complete spherical volume of space surrounding transmitting elements (e.g., antennas) of the network entity 515. On the ground, the UEs 522 that are not blocked by walls of buildings or other obstructions may receive the wireless broadcast 516 of the warning notification. On the lower floors of a building 518 (e.g., a high-rise residential, commercial, or mixed use building), a UE, such as UE 524 that is not otherwise blocked from the wireless broadcast 516 may receive the wireless broadcast 516 of the warning notification. On the middle floors of the building 518, a UE, such as UE 526 that is not otherwise blocked from the wireless broadcast 516 may receive the wireless broadcast 516 of the warning notification. However, on the upper floors, represented for illustrative and non-limiting purposes as the floors above a plane defined by the intersection of lines 520a and 520b, a UE, such as UE 528 may be unable to receive the wireless broadcast 516 of the warning notification. The inability to receive the wireless broadcast 516 may be attributable to, for example and without limitation, the shape of a transmission beam formed by the transmitting elements of the network entity 515, the pointing angle (e.g., antenna downtilt) of the transmission beam, structural material of the building 518 blocking the wireless broadcast 516, the distance between the antennas of the network entity 515 and the floors above the plane defined by the lines 520a and 520b (where the distance may reduce the power of the wireless broadcast 516 received at the UE 528 to a level that is not detectable by the UE 528), or any combination of these or one or more other reasons. Regardless of the reason, UE 528 is unable to receive the wireless broadcast 516 of the warning notification transmitted by a PLMN operator through a 3GPP network.

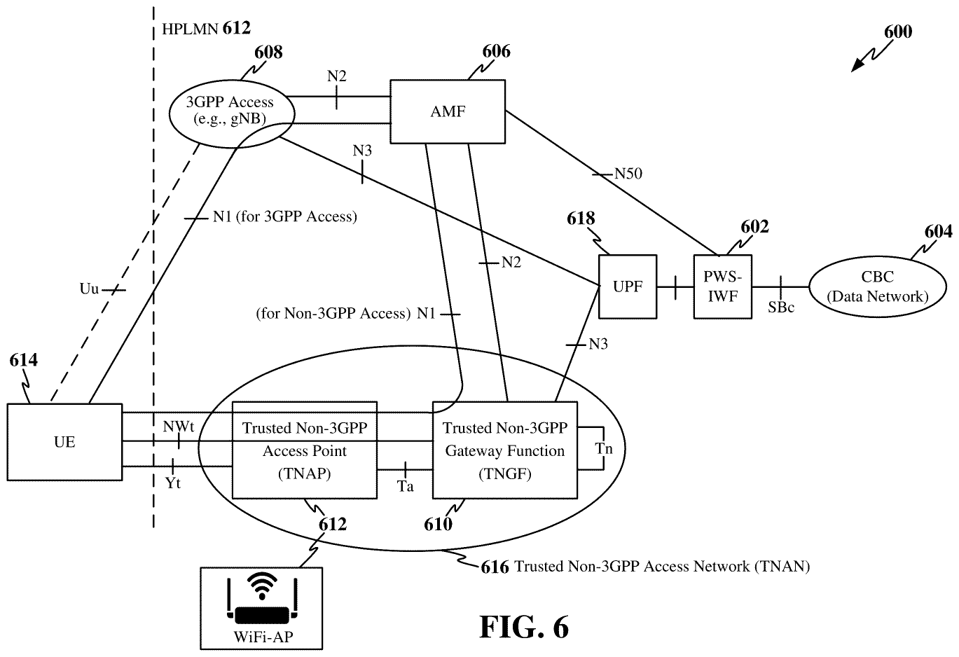

FIG. 6 depicts a network structure of a legacy 5GS PWS architecture 600 using a reference point representation showing how network functions interact with each other when the PWS-interworking function (IWF) 602 is used according to some aspects of the disclosure. FIG. 6 includes a Cell Broadcast Center (CBC) 604. The CBC 604 is an entity that connects a Cell Broadcast Entity (CBE) (not shown) to a PLMN operator's core network. A Cell Broadcast message may originate at the CBE. The Cell Broadcast message may be transmitted from the CBE to the CBC 604. The Cell Broadcast message may include message text, message destination, and message scheduling.

A PWS-IWF 602 may be associated with the CBC 604. The PWS-IWF 602 may be a logical function that translates from the SBc reference point, between the CBC 604 and the PWS-IWF 602, to an N50 reference point, between the PWS-IWF 602 and the AMF 606. The N50 reference point may be located between the AMF 606 and the PWS-IWF 602, or between a Cell Broadcast Center Function (CBCF) (not shown) and the AMF 606. In some examples, the CBCF may be an instantiation of an Application Function (AF) (not shown). The CBCF may use the services of the AMF 606 and a Network Repository Function (NRF) (not shown) for warning message delivery. The AMF 606 is an entity of the PLMN operator's core network. A user plane function (UPF) 618 is also provided in FIG. 6 for reference. A first N2 reference point lies between the AMF 606 and a 3GPP access entity 608 (e.g., a 3GPP RAN, a gNB). The UE 614 and the access entity 608 have a Uu reference point therebetween. In legacy 5GS PWS, services are only provided via the 3GPP access entity 608.

A second N2 reference point is between the AMF 606 and a trusted non-3GPP gateway function (TNGF) 610. A Trusted Non-3GPP Access Point (TNAP) 612 is between the TNGF 610 and the UE 614. The TNGF 610 and the UE 614 have a NWt reference point therebetween. The NWt reference point is transparent to the TNAP 612. An example of a TNAP 612 is a WiFi Access Point, as shown in FIG. 6. The TNGF 610 and the TNAP 612 may be collectively referred to as a trusted non-3GPP Access Network (TNAN) 616. The TNAN 616 may be associated with a WLAN. PWS over WLAN is not supported in legacy 5GS systems. Although the TNAN 616 between the AMF 606 and the UE 614 is depicted in FIG. 6, all PWS functionality in connection with the 5GS PWS of FIG. 6 is provided via the 3GPP access entity 608 (not the TNAN 616).

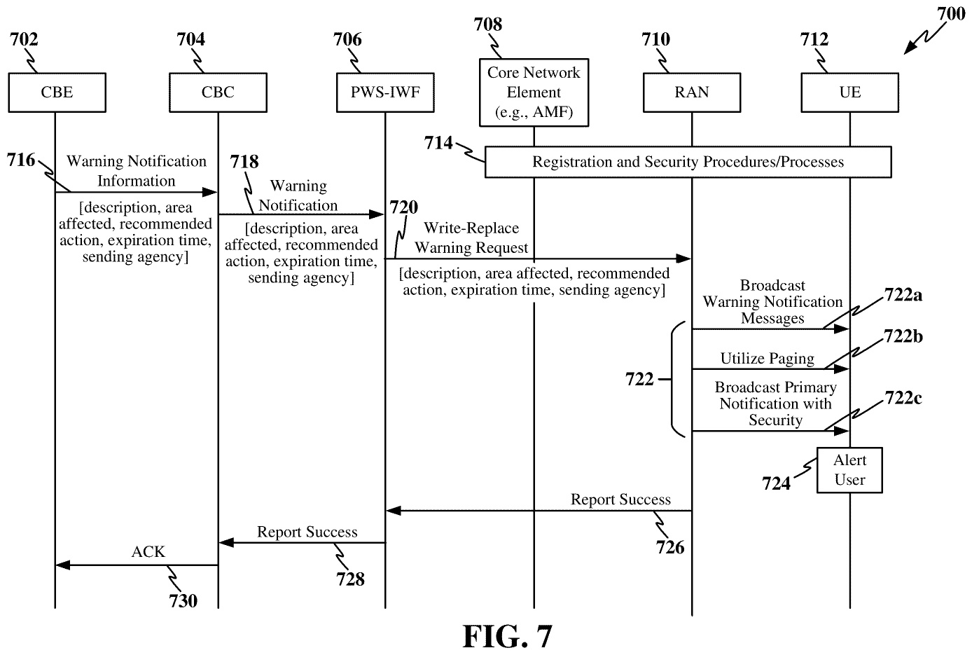

FIG. 7 is a call flow diagram 700 illustrating how the network structure of the legacy 5GS PWS architecture of FIG. 6 may operate in 3GPP according to some aspects of the disclosure. FIG. 7 includes a CBE 702 (as described in connection with FIG. 6), a CBC 704 (same as or similar to the CBC 604 as shown and described in connection with FIG. 6), a PWS-IWF 706 (same as or similar to the PWS-IWF 602 as shown and described in connection with FIG. 6), a core network element 708 (same as or similar to the AMF 606 as shown and described in connection with FIG. 6), a RAN 710 (same as or similar to the 3GPP access entity 608 as shown and described in connection with FIG. 6), and a UE 712 (same as or similar as the UE 614 as shown and described in connection with FIG. 6). Generally, the CBE 702 and CBC 704 provide information that may include warning notification content, warning notification type, and warning notification target area to the RAN 710. Note that FIG. 7 does not include a TNGF (such as the TNGF 610 as shown and illustrated in FIG. 6), or a TNAP (such as TNAP 612 as shown and illustrated in FIG. 6) because, as noted above in connection with FIG. 6, legacy 5G PWS does not support PWS over WLAN. By way of reference and not limitation, according to some aspects, the alert gateway 510 (as shown and described in connection with FIG. 5) may correspond to CBE 702 and the PLMN gateway 512 (as shown and described in connection with FIG. 5) may correspond to CBC 704. According to other aspects, the PLMN GW 512 may correspond to CBE 702.

At 714, the core network element 708, RAN 710, and UE 712 perform registration and security procedures/processes.

At 716, the CBE 702 transmits warning notification information to the CBC 704. The information may include the warning notification content, warning notification type, and warning notification target area. At 718, the CBC 704 transmits a warning notification to the PWS-IWF 706.

At 722, the PWS-IWF 706 transmits a write-replace warning request to the RAN 710. At 722, the RAN 710 may perform at least one of three actions: at 722a, the RAN 710 may broadcast the warning notification message using a special type of System Information (SI) message in a broadcast channel, at 722b the RAN may utilize paging to alert UEs in the target area, including UE 712, of a need to receive the warning notifications in the broadcast channel, the paging may include the type of the warning notification, or at 722c the RAN may broadcast dedicated alerts transmitted directly to each UE in the target area, including UE 712, instructing the UE to receive the warning notification in the broadcast channel. The dedicated alerts may include a primary warning notification with security.

At 724, after obtaining the warning notification utilizing at least one of 722a, 722b, or 722c, all UEs in the target area, including UE 712, alert their users. Alerts may be in the form of at least one of: a sound, a visual display, or a vibratory notification.

At 726, the RAN 710 reports success to the PWS-IWF 706. At 728, the PWS-IWF 706 reports success to the CBC 704. At 730, the CBC 704 transmits and ACK to the CBE 702.

There exists an interest to ensure that the public has the capability to receive timely and accurate alerts, warnings and critical information regarding disasters and other emergencies irrespective of what communications technologies individual members of the public use. As has been learned from disasters such as earthquakes, tsunamis, hurricanes, and wildfires, having the capability to receive timely and accurate alerts, warnings and critical information is essential to enable the public to take appropriate action to protect their families and themselves from serious injury, loss of life, or loss of property. Accordingly, extending PWS functionality beyond 3GPP RAN mechanisms may enhance the reliability, resiliency, and security of warning notifications to the public by expanding the mechanisms utilized to distribute warning notifications. 3GPP specifications allow a UE, such as the UEs of FIGS. 1, 2, 3, 5, 6, and/or 7, to access 3GPP core network services using non-3GPP access. The primarily used (e.g., and therefore most important) form of non-3GPP access is WLAN.

There are two types of WLAN access to 3GPP services: trusted and untrusted. The key difference is that, for trusted access, successful authentication for access to WLAN automatically authenticates the UE to access 3GPP services because the WLAN is “owned” by the 3GPP operator (PLMN). For untrusted access, the WLAN is “public” and the UE needs to authenticate separately. In either case, the UE establishes an Internet protocol security (IPSec) tunnel to the WLAN-3GPP trusted wireless access gateway (TWAG) for trusted access and ePDG for untrusted access). Since Rel-15, UEs over WLAN access use the same core network protocol to communicate with the 3GPP core network (NW) as over 3GPP access. The protocol is referred to as Non-Access Stratum (NAS) protocol.

In some cases, such as but not limited to the example of the upper floors of the building 518 as shown and described in connection with FIG. 5, it is not possible to provide ubiquitous cellular coverage. However, WLAN coverage may be found in places that do not have cellular coverage, such as on the upper floors of apartment high-rises, like the building 518 as shown and described in connection with FIG. 5. Therefore, in a location that does not have cellular coverage but does have WLAN coverage, WLAN access to 3GPP is a technology that may be used to provide PWS to UEs.

Pure WLAN access (divorced from interaction with a 3GPP system) may not be sufficient. Although applicable regulatory requirements for the Public Warning System (PWS) must be met, PWS is not presently supported over WLAN access to 3GPP. At least one difficulty in utilizing present WLAN technology (IEEE 802.11 standards) is that WLAN does not support broadcast of system information or paging in a way that is the same or similar to the way utilized in the 3GPP standards. System Information (SI) broadcast and paging may be understood as being the building blocks of PWS.

In order to reach prompt agreement by all parties associated with WLAN standards, it would be desirable to minimize the number of changes that would be made to the WLAN standards to permit PWS over WLAN. However, adding PWS to the WLAN standards may entail adding native support for 3GPP-like SI or paging over WLAN to the WLAN standards. The addition of native support does not appear to be feasible however, at least because the addition of native support would involve complex changes to the WLAN standards (and perhaps even to hardware manufactured according to the WLAN standards). Additionally, further complicating the problem, is the fact that the WLAN standard setting body and the 3GPP standard setting body are different organizations, with different methodologies of proposing, testing, and implementing changes. However, some interfaces between 3GPP and WLAN presently exist.

For example, WLAN supports providing 3GPP-specific information using an Access Network Query Protocol (ANQP) protocol. ANQP is a query-response protocol that may be utilized to provide a UE, over WLAN, with 3GPP Information Elements (IEs). In legacy networks, these IEs may be used to identify the 3GPP PLMNs reachable to the UE via a given WLAN. Additionally, as mentioned above, since Rel-15, UEs have used NAS protocol to communicate with the 3GPP core network over WLAN. NAS protocol supports a NOTIFICATION message, which is a message used to alert a UE about an action the UE is expected to take (e.g., alert the UE that downlink data is awaiting over 3GPP access).

The NOTIFICATION message is a direct message that can only be sent to UEs in connected mode (over RAN); however, the NOTIFICATION message can also be sent to the UE over WLAN. The NOTIFICATION message may, in a way, emulate paging over WLAN, except that the paging is via direct signaling instead of broadcast.

When a UE is registered for 3GPP services over WLAN, the UE will always be in connected mode if WLAN is available. The NAS layer of the 3GPP protocol stack over WLAN will automatically establish a direct NAS signaling connection to the 3GPP core NW (e.g., to the AMF, such as the AMF 606 as shown and described in connection with FIG. 6 or the core network element 708 as shown and described in connection with FIG. 7) when WLAN is connected in the lower layers (WLAN access stratum layers).

This is only if the UE is already registered to the PLMN over WLAN. However, there is no automatic trigger for registration with a PLMN over WLAN.

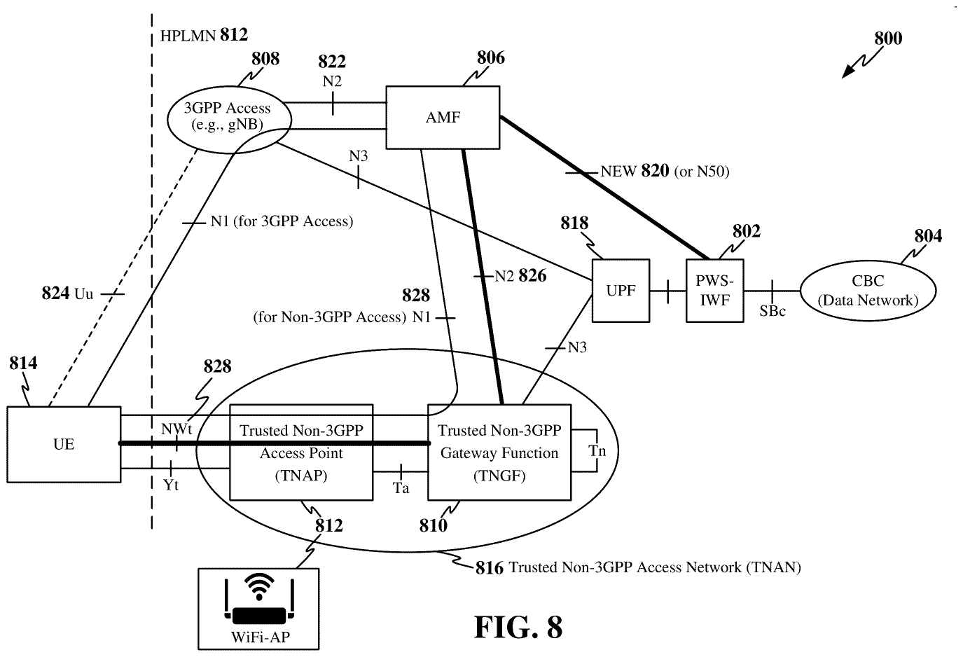

FIG. 8 depicts a network structure of a 5GS PWS architecture 800 using a reference point representation showing how network functions interact with each other when a PWS-IWF 802 and access and mobility management function (AMF 806) that support PWS over WLAN are used according to some aspects of the disclosure. Using the 5GS PWS architecture 800 of FIG. 8, PWS over WLAN may be supported. Similar to FIG. 6, FIG. 8 includes a Cell Broadcast Center (CBC) 804. The CBC 804 is an entity that connects a Cell Broadcast Entity (CBE) (not shown) to a PLMN operator's core network. A Cell Broadcast message may originate at the CBE. The Cell Broadcast message may be transmitted from the CBE to the CBC 804. The Cell Broadcast message may include message text, message destination, and message scheduling. A PWS-IWF 802 may be associated with the CBC 804. The PWS-IWF 802 may be a logical function that translates from the SBc reference point, between the CBC 804 and the PWS-IWF 802, to an N50 reference point, between the PWS-IWF 802 and the AMF 806. The N50 reference point presently has PWS functionality; however, a new reference point (referred to herein as NEW 820), or the N50 reference point, or a modified N50 reference point may be utilized in connection with PWS over WLAN functionality. A user plane function (UPF) 818 is also provided in FIG. 8 for reference. A first N2 822 reference point lies between the AMF 806 and a 3GPP access entity 808 (e.g., a 3GPP RAN, a gNB). The UE 814 and the 3GPP access entity 808 have a Uu 824 reference point therebetween. As with the legacy 5GS PWS of FIG. 6, PWS could be provided to the UE 814 from the AMF 806, using the first N2 822 reference point between the AMF 806 and the 3GPP Access Entity 808 and the Uu 824 reference point between the 3GPP Access Entity 808 and the UE 814. Similar to FIG. 7, and again by way of reference and not limitation, according to some aspects, the PLMN gateway 512 (as shown and described in connection with FIG. 5) may correspond to CBC 804.

However, even if 3GPP access is available in a given location, according to some aspects, WLAN may be used to transmit PWS information to a UE. According to some aspects herein, the AMF 806 may have a database that stores UE contexts. The UE contexts may indicate which UEs are registered over non-3GPP access, which UEs are registered over 3GPP access, and which UEs are registered over both non-3GPP access and 3GPP access. Using this data, the AMF 806 may determine which UE may obtain PWS over RAN and which UE may obtain PWS over WLAN. Generally, a UE that is registered over both non-3GPP access and 3GPP access may be provided PWS over RAN. At least one difference between PWS over RAN and PWS over WLAN is that PWS over RAN is broadcast to all UEs in a given area (e.g., a notification area) on a broadcast channel, while PWS over WLAN is UE specific (as WLAN does not have broadcast capability similar to that available in 3GPP systems).

For example, if UE 814 was only registered for 3GPP access, then the AMF 806 may determine to use PWS over RAN. If UE 814 was registered over both non-3GPP access and 3GPP access, then according to one aspect the AMF 806 may determine to use PWS over RAN in favor of PWS over WLAN because, for example, PWS over RAN in a broadcast channel may be more efficient than PWS over WLAN addressed to a specific UE. According to another aspect, if UE 814 was registered over both non-3GPP access and 3GPP access, the AMF 806 may send PWS information using both PWS over RAN and PWS over WLAN. According to still another aspect, for example, where UE 814 was registered over both non-3GPP access and 3GPP access, but UE 814 has lost connection with the 3GPP system, the AMF 806 may determine to use PWS over WLAN. Of course, if UE 814 is only registered for non-3GPP access, then the AMF 806 may determine to use PWS over WLAN.

If UE 814 is in a warning notification area and the AMF 806 has determined to use PWS over WLAN in connection with UE 814, then, according to some aspects, the AMF 806 may use NAS protocol to send a NAS NOTIFICATION message to UE 814, where the NOTIFICATION message may alert UE 814 that it has an action pending. The AMF 806 may send the message over the second N2 826 reference point between the AMF 806 and a trusted non-3GPP gateway function (TNGF) 810 for this purpose. The TNGF 810 may provide the NAS NOTIFICATION message to the UE 814 via a secure tunnel using the NWt 828 reference point. The NWt 828 reference point is transparent to the TNAP 812. Alternatively, the AMF 806 may send the NAS NOTIFICATON message over the N1 828 reference point between the AMF 806 and the UE 814. If sent over the N1 828 reference point, the NAS Notification message is transparent to both the TNGF 810 and the TNAP 812. An example of a TNAP 812 is a WiFi Access Point, as shown in FIG. 8. The TNGF 810 and the TNAP 812 may be collectively referred to as a trusted non-3GPP Access Network (TNAN) 816. The TNAN 816 may be associated with a WLAN. Accordingly, PWS over WLAN may be supported using the 5GS systems architecture of FIG. 8.

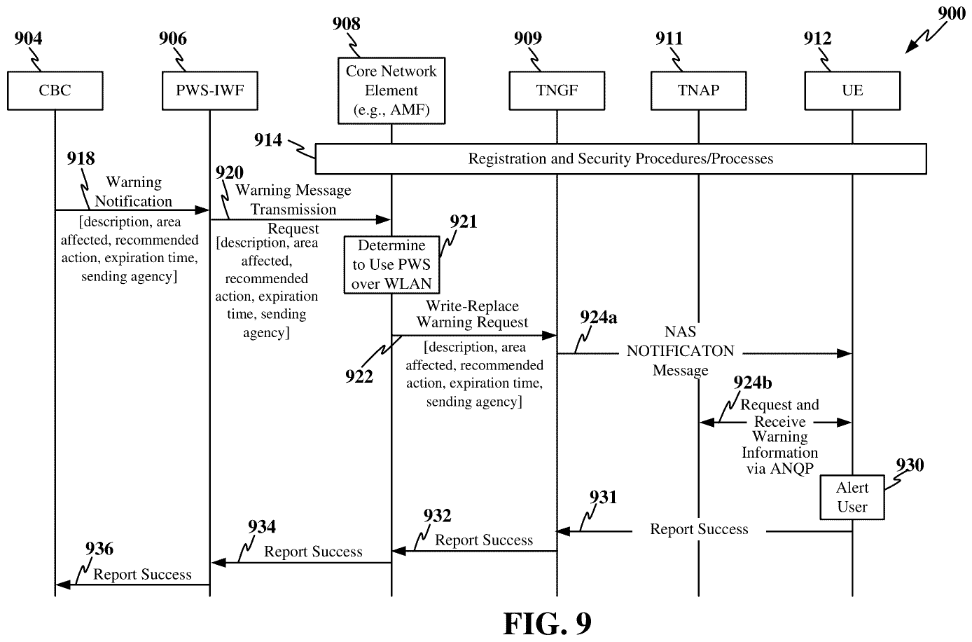

FIG. 9 is a call flow diagram 900 that illustrates how the network structure of the 5GS PWS architecture of FIG. 8 may operate in a 3GPP system to provide PWS over WLAN according to some aspects of the disclosure. FIG. 9 includes a CBC 904 (same as or similar to the CBC 804 as shown and described in connection with FIG. 8), a PWS-IWF 802 (same as or similar to the PWS-IWF 802 as shown and described in connection with FIG. 8), a core network element 908 (same as or similar to the AMF 806 as shown and described in connection with FIG. 8, an access point to a core network), a TNGF 909 (same as or similar to the TNGF 810 as shown and described in connection with FIG. 8), a TNAP 911 (same as or similar to the TNAP 812 as shown and described in connection with FIG. 8), and a UE 912 (same as or similar to the UE 814 as shown and described in connection with FIG. 8). Note that FIG. 9 does not include 3GPP Access Entity (such as the 3GPP Access Entity 808 as shown and illustrated in FIG. 8) because the example of FIG. 9 is an example of PWS over WLAN. In FIG. 9, even though 3GPP access is available, the AMF (such as the AMF 806 as shown and described in connection with FIG. 8) is directing the PWS to the UE 912 over WLAN via the TNGF 909 (and the TNAP 911).

At 914, the core network element 908, TNGF 909, TNAP 911, and UE 912 perform registration and security procedures/processes.

At 918, the CBC 904 transmits the warning notification to the PWS-IWF 906. The warning notification may be in response to receiving a warning notification from a CBE (not shown) (the same or similar to the CBE 702 as shown and described in connection with FIG. 7). The warning notification may provide information that may include warning notification content, warning notification type, and warning notification target area to core network element 908 (the AMF, the access point to the core network).

At 920, the PWS-IWF 906 transmits a Warning Message Transmission Request to the core network element 908.

At 921, the core network element 908 determines to utilize PWS over WLAN to notify the UE 912 of the Warning Message.

At 922 the core network element 908 transmits a Write-Replace Warning Request to the TNGF 909. The Write-Replace Warning Request may include, for example, a warning description, an area affected, recommended action, expiration time, sending agency.

At 924a, the TNGF 909 may utilize a NAS NOTIFICATION message to alert the UE 912 of a pending action. The NOTIFICATION message may indicate that the pending action is related to PWS. Alternatively, at 924a, the TNGF 909 may transmit a warning message to the UE 912. The warning message may include, for example, a warning description, an area affected, recommended action, expiration time, sending agency.

At 924b, if (at 924b) the TNGF 909 only notified the UE 912 of a pending action, or if the TNGF 909 did not provide all of the information regarding the warning to the UE 912, then the UE 912 may utilize ANQP to request and receive additional information related to the warning from the TNAP 911. The communications at 924a are exchanged between the TNGF 909 and the UE 912 via the TNAP 911; the communications at 924a are transparent to the TNAP 911.

At 930, after obtaining information related to the warning notification at 924a or 924a and 924b, the UE 912 may alert its user. Alerts may be in the form of at least one of: a sound, a visual display, or a vibratory notification.

At 931, the UE 912 may report success to the TNGF 909. At 932, the TNGF 909 reports success to the core network element 908. At 934 the core network element 908 reports success to the PWS-IWF 906. At 936, the PWS-IWF 906 reports success to the CBC 904. The CBC 904 may transmit an ACK to a CBE (not shown).

As described above, the Public Warning System (PWS) presently services UEs registered with a 3GPP network. PWS may presently be a unique 3GPP feature and is a valuable and important service that benefits all users that have access to the PWS service. It is beneficial, therefore, to extend the PWS service to UEs that are not registered with a 3GPP network. Although UEs have limited ability to access 3GPP networks over a non-3GPP wireless local area network (WLAN), PWS over WLAN is not presently supported by 3GPP networks. Aspects described herein leverage some capability of a UE that is not registered with a 3GPP network (e.g., because connection is unavailable or temporarily lost) to obtain 3GPP PWS service via a non-3GPP network such as a WLAN. The UEs that are registered with the non-3GPP network (via WLAN) may receive notifications related to PWS over WLAN and obtain information pertinent to warning notifications from 3GPP core network functions.

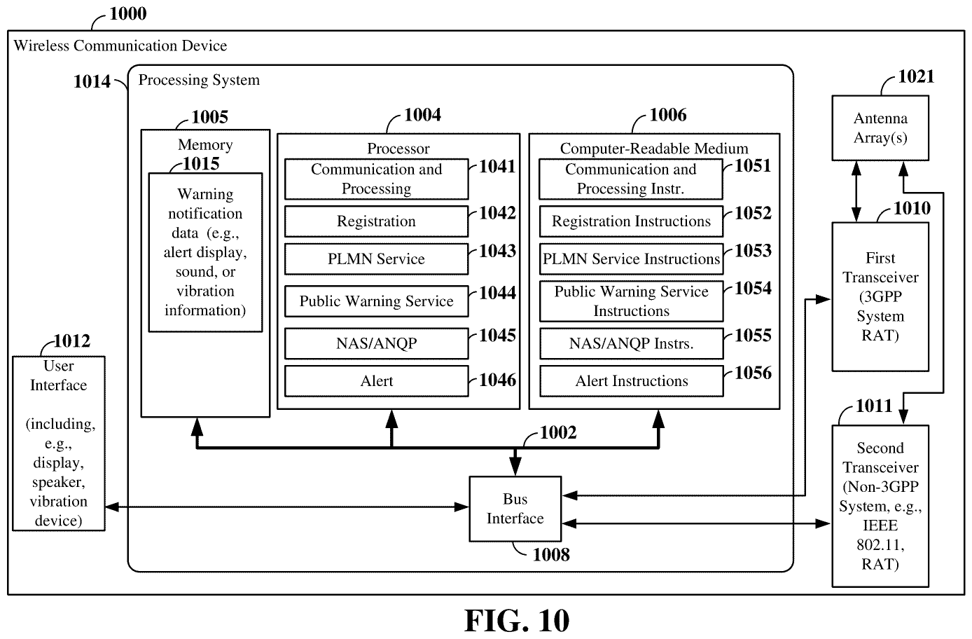

FIG. 10 is a block diagram illustrating an example of a hardware implementation of a wireless communication device 1000 (e.g., user equipment, a scheduled entity) employing a processing system 1014 according to some aspects of the disclosure. The wireless communication device 1000 may be similar to, for example, any of the wireless communication devices, UEs, or scheduled entities of FIGS. 1, 2, 3, 5, 6, 7, 8, and/or 9.

In accordance with various aspects of the disclosure, an element, any portion of an element, or any combination of elements may be implemented with a processing system 1014 that includes one or more processors, such as processor 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1000 may be configured to perform any one or more of the functions described herein. That is, the processor 1004, as utilized in the wireless communication device 1000, may be used to implement any one or more of the methods or processes described and illustrated, for example, in FIGS. 5, 6, 7, 8, and/or 9.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable medium 1006). The bus 1002 may also link various other circuits such as timing sources, peripherals, voltage regulators, and power management circuits, which are well known to persons having ordinary skill in the art, and therefore, will not be described any further.

A bus interface 1008 provides an interface between the bus 1002 and a first transceiver 1010. The first transceiver 1010 may be, for example, a wireless transceiver. The first transceiver 1010 may be operational with a first RAT (e.g., a 3GPP system RAT). The bus interface 1008 may also provide an interface between the bus 1002 and a second transceiver 1011. The second transceiver 1011 may be, for example, a wireless transceiver. The second transceiver 1011 may be operational with a second RAT (e.g., a non-3GPP system compliant RAT, such as an IEEE 802.11 (WiFi®) system RAT). The first transceiver 1010 and the second transceiver 1011 may provide respective means for communicating with various other apparatus and core networks over a transmission medium (e.g., air interface). The first transceiver 1010 and the second transceiver 1011 may further be coupled to one or more respective antenna array(s) 1021. The bus interface 1008 further provides an interface between the bus 1002 and a user interface 1012 (e.g., keypad, display, touch screen, speaker, microphone, control features, vibration circuit/device, etc.). Of course, such a user interface 1012 is optional, and may be omitted in some examples.

One or more processors, such as processor 1004, may be responsible for managing the bus 1002 and general processing, including the execution of software stored on the computer-readable medium 1006. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1006. The software, when executed by the processor 1004, causes the processing system 1014 to perform the various processes and functions described herein for any particular apparatus.

The computer-readable medium 1006 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product or article of manufacture. By way of example, a computer program product or article of manufacture may include a computer-readable medium in packaging materials. In some examples, the computer-readable medium 1006 may be part of the memory 1005. Persons having ordinary skill in the art will recognize how best to implement the described functionality presented throughout this disclosure depending on the particular application and the overall design constraints imposed on the overall system. The computer-readable medium 1006 and/or the memory 1005 may also be used for storing data that is manipulated by the processor 1004 when executing software. For example, the memory 1005 may store warning notification data 1015, including, for example, patterns to display on the user interface 1012 in connection with warning notifications, sounds to emit from a speaker of the user interface 1012 in connection with warning notifications, or frequency and amplitude sequences utilized to excite a vibration device of the user interface 1012 in connection with warning notifications.

In some aspects of the disclosure, the processor 1004 may include communication and processing circuitry 1041 configured for various functions, including for example communicating with a network entity (e.g., a gNB, an eNB, a base station, a scheduled entity, a 3GPP access point, a non-3GPP access point, an AMF (such as AMF 806, core network element 908, as shown and described in connection with FIGS. 8 and 9 respectively), a network core (e.g., a 5G core network) or a network function (such as AMF 806, core network element 908, as shown and described in connection with FIGS. 8 and 9 respectively), another wireless communication device (e.g., a UE, a scheduled entity), and/or any other entity, such as, for example, local infrastructure, or an entity communicating with the wireless communication device 1000 via the Internet, such as a core network of a network provider or a PLMN operator. In some examples, the communication and processing circuitry 1041 may include one or more hardware components that provide the physical structure that performs processes related to wireless communication (e.g., signal reception and/or signal transmission) and signal processing (e.g., processing a received signal and/or processing a signal for transmission). The communication and processing circuitry 1041 may further be configured to execute communication and processing instructions 1051 (e.g., software) stored on the computer-readable medium 1006 to implement one or more functions described herein.

In some aspects of the disclosure, the processor 1004 may include registration circuitry 1042 configured for various functions. The registration circuitry 1042 may include security circuitry (not shown). The functions of the registration circuitry 1042 may include, for example, performing a registration procedure with a public land mobile network (PLMN) via a wireless local area network (WLAN). In some examples, the functions of the registration circuitry 1042 may include performing registration and security procedures with PLMN via the WLAN. In some examples, the functions of the registration circuitry 1042 may include performing registration procedures (or registration and security procedures) with PLMN via the WLAN and/or performing registration procedures (or registration and security procedures) with PLMN via a RAN as variously shown and described in connection with FIGS. 7 and 9, for example. According to some aspects, the wireless communication device 1000, utilizing the registration circuitry 1042, for example, may be preconfigured to perform the registration procedure via the WLAN to obtain the public warning service. According to some aspects, the functions of the registration circuitry 1042 may include determining that the wireless communication device 1000 is not registered with the PLMN, and performing the registration procedure in response to the determining. The registration circuitry 1042 may further be configured to execute registration instructions 1052 (e.g., software) stored on the computer-readable medium 1006 to implement one or more functions described herein.

In some aspects of the disclosure, the processor 1004 may include PLMN service circuitry 1043 configured for various functions, including, for example, obtaining PLMN services over the WLAN subsequent to performing the registration procedure (associated with the registration circuitry 1042 and registration instructions 1052). The PLMN services may include at least a public warning service. The PLMN service circuitry 1043 may further be configured to execute PLMN service instructions 1053 (e.g., software) stored on the computer-readable medium 1006 to implement one or more functions described herein.

In some aspects of the disclosure, the processor 1004 may include public warning service circuitry 1044 configured for various functions, including, for example, receiving a public warning service notification via the public warning service. According to some aspects, the public warning service notification is one of: a primary public warning service notification, a secondary public warning service notification, or both the primary public warning service notification and the secondary public warning service notification. According to some aspects, the public warning service notification indicates that public warning service information is available from the PLMN via the WLAN. According to some aspects, the functions of the public warning service circuitry 1044 may include receiving the public warning service notification in a non-access stratum (NAS) message. In some examples, the functions of the public warning service circuitry 1044 may include receiving the public warning service notification in a non-access stratum (NAS) message while the wireless communication device 1000 is in a connected mode. According to some aspects, the NAS message may be a NAS NOTIFICATION message. The NAS NOTIFICATION message may indicate to the public warning service circuitry 1044 that the wireless communication device 1000 has public warning service information pending upload. The upload may be accomplished, for example over a WLAN, with the use of the NAS/ANQP circuitry 1045, by use of an ANQP protocol query(s) and ANQP protocol response(s). The query(s) and response(s) may be in a form of PWS information elements (IEs) obtained from a 3GPP system of the PLMN operator via a non-3GPP system over the WLAN. The public warning service circuitry 1044 may further be configured to execute public warning service instructions 1054 (e.g., software) stored on the computer-readable medium 1006 to implement one or more functions described herein.

In some aspects of the disclosure, the processor 1004 may include NAS/ANQP circuitry 1045 configured for various functions, including, for example, retrieving public warning service information from the PLMN via the WLAN in response to receiving the public warning service notification. In some aspects, the various functions of the NAS/ANQP circuitry 1045 may include initiating an access network query protocol (ANQP) procedure in support of the retrieving the public warning service information from the PLMN via the WLAN. In some aspects, the various functions of the NAS/ANQP circuitry 1045 may include retrieving the public warning service information utilizing an access network query protocol (ANQP) procedure, where the public warning service information is one of: a primary public warning service notification, a secondary public warning service notification, or both the primary public warning service notification and a secondary public warning service notification. In some examples, the various functions of the functions NAS/ANQP circuitry 1045 may facilitate NAS protocol communication between, for example, the wireless communication device 1000 and an AMF (such as the AMF 806, core network element 908, as shown and described in connection with FIGS. 8 and 9, respectively). According to some aspects, the public warning service notification information retrieved utilizing the NAS/ANQP circuitry 1045 may be retrieved from the PLMN via the WLAN utilizing the antenna array(s) 1021 and the second transceiver 1011 (e.g., a transceiver operating according to non-3GPP RAT. In some examples the NAS/ANQP circuitry 1045 may be configured to obtain public warning service information from a core network entity (such as the AMF) by utilizing ANQP protocol to transmit a query(s) and receive a response(s). In some examples, the NAS message may include full or partial PWS related information. For example, the NAS message may be substantially similar to a primary public warning service notification, a secondary public warning service notification, or both the primary public warning service notification and the secondary public warning service notification. The NAS/ANQP circuitry 1045 may further be configured to execute ANQP and/or NAS instructions 1055 (e.g., software) stored on the computer-readable medium 1006 to implement one or more functions described herein.

In some aspects of the disclosure, the processor 1004 may include alert circuitry 1046 configured for various functions, including, for example, at least one of: displaying information corresponding to data received in a warning notification associated with a public warning service on a display screen of the wireless communication device 1000 (e.g., a display screen of the user interface 1012), causing a speaker of the wireless communication device 1000 to emit a sound associated with the warning notification (e.g., a speaker of the user interface 1012), or causing a vibration circuit of the wireless communication device 1000 to vibrate (e.g., a vibration circuit of the user interface 1012. The alert circuitry 1046 may further be configured to execute alert instructions 1056 (e.g., software) stored on the computer-readable medium 1006 to implement one or more functions described herein.

According to some aspects, the memory 1005 may store warning notification data 1015, including one or more of: warning display information (e.g., colors, warning image patterns, images, etc.), sound information (e.g., tones, modulations, alert sound patterns, alert sounds, etc.), or vibration information (e.g., warning vibration frequency, warning vibration amplitude, warning vibration patterns).

In general, a wireless communication device, such as wireless communication device 1000 may generally include a memory 1005, a first transceiver 1010 configured to operate utilizing a 3GPP system radio access technology (RAT) associated with cellular communications, a second transceiver 1011 configured to operate utilizing a non-3GPP system RAT (such as WLAN IEEE 802.11), and a processor 1004 coupled to the first transceiver 1010, the second transceiver 1011, and the memory 1005.

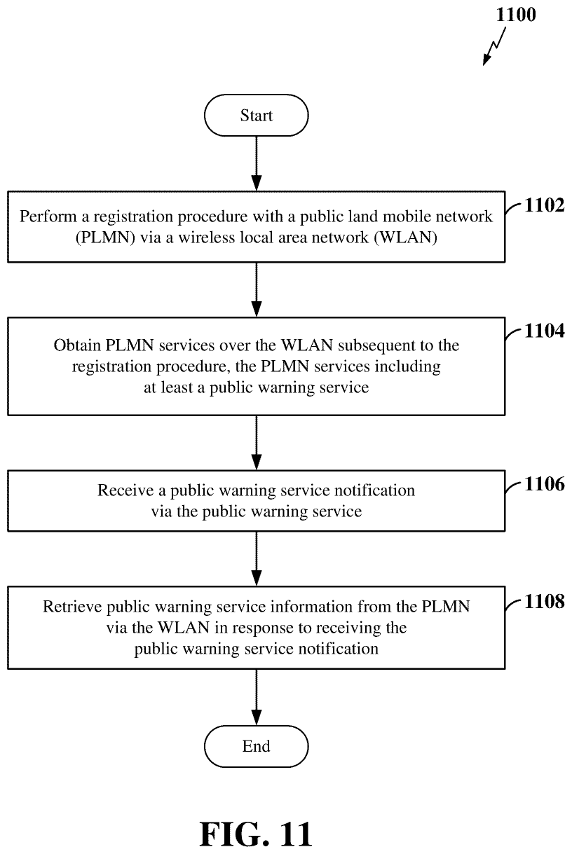

FIG. 11 is a flow chart illustrating an example process 1100 (e.g., a method) of wireless communication at a wireless communication device in accordance with some aspects of the disclosure. As described below, some or all illustrated features may be omitted in a particular implementation within the scope of the present disclosure, and some illustrated features may not be required for implementation of all embodiments. In some examples, the process 1100 may be carried out by the wireless communication device 1000 as illustrated and described in connection with FIG. 11. The wireless communication device 1000 may be similar to, for example, any of the wireless communication devices, UEs, or scheduled entities of FIGS. 1, 2, 3, 5, 6, 7, 8, 9, and/or 10. In some examples, the process 1100 may be carried out by any suitable apparatus or means for carrying out the functions or algorithm described below.

At block 1102, the wireless communication device may perform a registration procedure with a public land mobile network (PLMN) via a wireless local area network (WLAN). For example, the registration circuitry 1042, as shown and described in connection with FIG. 11, may provide a means for performing a registration procedure with a public land mobile network (PLMN) via a wireless local area network (WLAN). According to some aspects, the wireless communication device may be preconfigured to perform the registration procedure via the WLAN to obtain the public warning service. In some examples, the wireless communication device may be configured to determine, prior to performing the registration procedure, that the wireless communication device is not registered with the PLMN. Subsequently, the wireless communication may perform the registration procedure in response to the determining (that the wireless communication device is not registered with the PLMN).

At block 1104, the wireless communication device may obtain PLMN services over the WLAN subsequent to the registration procedure, the PLMN services including at least a public warning service. For example, the PLMN service circuitry 1043, as shown and described in connection with FIG. 11, may provide a means for obtaining PLMN services over the WLAN subsequent to performing the registration procedure, the PLMN services including at least a public warning service. According to some aspects, the public warning service notification may be one of: a primary public warning service notification, a secondary public warning service notification, or both the primary public warning service notification and the secondary public warning service notification. In some examples, the public warning service notification may indicate that public warning service information is available from the PLMN via the WLAN.

At block 1106, the wireless communication device may receive a public warning service notification sepvia the public warning service. For example, the public warning service circuitry 1144, as shown and described in connection with FIG. 11, may provide a means for receiving a public warning service notification via the public warning service. In some examples, the wireless communication device may receive the public warning service notification in a non-access stratum (NAS) message. In some examples, the wireless communication device may receive the public warning service notification in a non-access stratum (NAS) message while the wireless communication device is in a connected mode. In some examples, the NAS message may be a NAS NOTIFICATION message.

At block 1108, the wireless communication device may retrieve public warning service information from the PLMN via the WLAN in response to receiving the public warning service notification. For example, the NAS or ANQP circuitry 1145 may provide a means for retrieving public warning service information from the PLMN via the WLAN in response to receiving the public warning service notification. According to some examples, the wireless communication device may initiate an access network query protocol (ANQP) procedure in support of the retrieving the public warning service information from the PLMN via the WLAN. In some aspects, the wireless communication device may retrieve the public warning service information utilizing an access network query protocol (ANQP) procedure, where the public warning service information is one of: a primary public warning service notification, a secondary public warning service notification, or both the primary public warning service notification and a secondary public warning service notification.

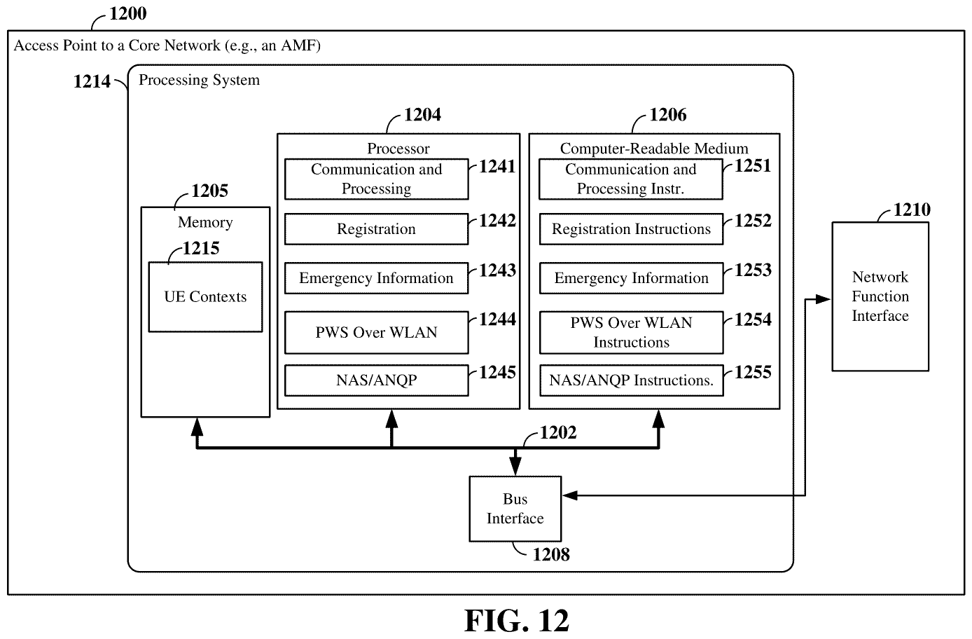

FIG. 12 is a block diagram illustrating an example of a hardware implementation of an access point to a core network 1200 employing a processing system 1214 according to some aspects of the disclosure. In one example, the access point to the core network may be an access and mobility management function (AMF). Although associated with a function, the access point to a core network 1200 may be implemented in hardware as shown in the example of FIG. 12. The access point to a core network 1200 may be similar to, for example, any of the AMF 806, core network element 908, or AMF 1408 as shown and described in connection with FIGS. 8, 9, and 14, respectively.

The processing system 1214 may be substantially the same as the processing system 1114 illustrated in FIG. 11, including a bus interface 1208, a bus 1202, memory 1205, one or more processors, such as processor 1204, and a computer-readable medium 1206. In accordance with various aspects of the disclosure, an element, or any portion of an element, or any combination of elements may be implemented with a processing system 1214 that includes one or more processors, such as processor 1204. Furthermore, the access point to a core network 1200 may include a network function interface 1210, suitable to interface with other aspects of the core network, such as, for example, a PWS-IWF, a TNGF, and a RAN. a user interface 1212. The processor 1204, as utilized in an access point to a core network 1200, may be used to implement any one or more of the processes described herein and illustrated, for example, in FIGS. 8, 9, and/or 10.

In some aspects of the disclosure, the processor 1204 may include communication and processing circuitry 1241 configured for various functions, including for example communicating with other entities of the core network, a PWS-IWF, a TNGF, and a RAN. In some examples, the communication and processing circuitry 1241 may include one or more hardware components that provide the physical structure that performs processes related to communication (e.g., data reception and/or data transmission) and signal processing (e.g., processing received data and/or processing data for transmission). The communication and processing circuitry 1241 may further be configured to execute communication and processing instructions 1251 (e.g., software) stored on the computer-readable medium 1206 to implement one or more functions described herein.

In some aspects of the disclosure, the processor 1204 may include registration circuitry 1242 configured for various functions. The registration circuitry 1242 may include security circuitry (not shown). The functions of the registration circuitry 1242 may include, for example, performing a registration procedure with UE via a wireless local area network (WLAN). In some examples, the WLAN may be accessed by one or more communication devices at a trusted non-3GPP access point. In some examples, the functions of the registration circuitry 1242 may include performing registration procedures (or registration and security procedures) with UE via the WLAN and/or performing registration procedures (or registration and security procedures) with UE via a RAN as variously shown and described in connection with FIGS. 7 and 9, for example. The registration circuitry 1242 may further be configured to execute registration circuitry instructions 1252 (e.g., software) stored on the computer-readable medium 1206 to implement one or more functions described herein.

In some aspects of the disclosure, the processor 1204 may include emergency information circuitry 1243 configured for various functions, including, for example, receiving emergency information associated with a public warning service. In some examples, the emergency information may be received at the access point to the core network from a cell broadcast center (CBC). In some examples, the emergency information may be received at the access point to the core network from the CBC via a PWS-IWF. In some examples, the emergency information may include a target area. the target area may be a warning notification target area, which may be a geographical area that may be affected by the adverse effects of the event that is the subject of the warning notification. The emergency information circuitry 1243 may further be configured to execute emergency information instructions 1253 (e.g., software) stored on the computer-readable medium 1206 to implement one or more functions described herein.

In some aspects of the disclosure, the processor 1204 may include PWS over WLAN circuitry 1244 configured for various functions, including, for example, transmitting the emergency information to one or more wireless communication devices registered with the wireless communication network via a wireless local area network (WLAN). According to some aspects, the PWS over WLAN circuitry 1244 may be configured for additional functions, such as, for example, transmitting the emergency information only to those of the one or more wireless communication devices that are registered with the wireless communication network exclusively via the WLAN. Furthermore, the PWS over WLAN circuitry 1244 may also be configured to transmit the emergency information using a non-access stratum (NAS) protocol Notification message. Furthermore, other ones of the various functions may include transmitting the emergency information to a WLAN-3GPP gateway in the target area. Still other ones of the various functions may include transmitting the emergency information to a WLAN access point in the target area via a WLAN-3GPP gateway. According to some aspects, transmitting the emergency information further includes transmitting an indication to the one or more wireless communication devices that the emergency information is available using an access network query protocol (ANQP) protocol. PWS over WLAN circuitry 1244 may further be configured to execute PWS over WLAN instructions 1254 (e.g., software) stored on the computer-readable medium 1206 to implement one or more functions described herein.

In some aspects of the disclosure, the processor 1204 may include NAS/ANQP circuitry 1245 configured for various functions, including, for example, providing public warning service information to a UE via the WLAN. In some aspects, the various functions of the NAS/ANQP circuitry 1245 may include implementing an access network query protocol (ANQP) procedure in support of the provision of the public warning service information to the UE via the WLAN. In some aspects, the various functions of the NAS/ANQP circuitry 1245 may include responding to ANQP queries by providing public warning service information, where the public warning service information is one of: a primary public warning service notification, a secondary public warning service notification, or both the primary public warning service notification and a secondary public warning service notification. In some examples, the various functions of the NAS/ANQP circuitry 1245 may include facilitating NAS protocol communication between, for example, a wireless communication device and the access point to a core network 1200. According to some aspects, the public warning service notification information provided utilizing the NAS/ANQP circuitry 1245 may be provided from the access point to a core network 1200 (of the PLMN) via the WLAN by utilizing ANQP protocol to receive a query(s) and transmit (respond with) a response(s). In some examples, the NAS message may include full or partial PWS related information. For example, the NAS message may be substantially similar to a primary public warning service notification, a secondary public warning service notification, or both the primary public warning service notification and the secondary public warning service notification. The NAS/ANQP circuitry 1245 may further be configured to execute ANQP and/or NAS instructions 1255 (e.g., software) stored on the computer-readable medium 1206 to implement one or more functions described herein.

According to some aspects, the memory 1205 may store, in a UE context storage location 1215, UE contexts of UEs registered over 3GPP, registered over WLAN, and registered over both 3GPP and WLAN.

In general, an access point to a core network, such as the access point to a core network 1200, may generally include a memory 1205, and a processor 1204 coupled to the memory 1205.

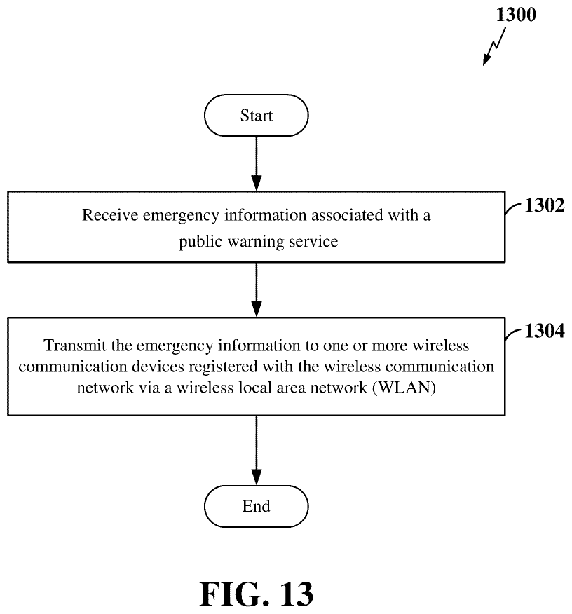

FIG. 13 is a flow chart illustrating an example process 1300 (e.g., a method) of wireless communication at an access point to a core network according to some aspects of the disclosure. In one example, the access point to the core network may be an access and mobility management function (AMF). As described below, some or all illustrated features may be omitted in a particular implementation within the scope of the present disclosure, and some illustrated features may not be required for implementation of all embodiments. In some examples, the process 1300 may be carried out by the access point to a core network 1200 as illustrated and described in connection with FIG. 13. The access point to a core network 1200 may be similar to, for example, any of the AMF 806, core network element 908, or AMF 1408 as shown and described in connection with FIGS. 8, 9, and 14, respectively. In some examples, the process 1300 may be carried out by any suitable apparatus or means for carrying out the functions or algorithm described below.

At block 1302, the access point to a core network may receive emergency information associated with a public warning service. For example, the emergency information circuitry 1342, as shown and described in connection with FIG. 13, may provide a means for receiving emergency information associated with a public warning service. According to one aspect, the emergency information may be received from a cell broadcast center (CBC). In one example, the emergency information includes a target area.

At block 1304, the access point to a core network may transmit the emergency information to one or more wireless communication devices registered with the wireless communication network via a wireless local area network (WLAN). For example, the PWS over WLAN circuitry 1343, as shown and described in connection with FIG. 13, may provide a means for transmitting the emergency information to one or more wireless communication devices registered with the wireless communication network via a wireless local area network (WLAN). In one example, the WLAN may be accessed by the one or more communication devices at a trusted non-3GPP access point. According to one aspect, the access point to a core network may transmit the emergency information only to those of the one or more wireless communication devices that are registered with the wireless communication network exclusively via the WLAN. In one example, the emergency information may be transmitted using a non-access stratum (NAS) protocol Notification message. In one example, the NAS message may be a NAS NOTIFICATION message. According to one aspect, the access point to the core network may transmit the emergency information to a WLAN-3GPP gateway in the target area. According to one aspect, the access point to the core network may transmit the emergency information to a WLAN access point in the target area via a WLAN-3GPP gateway. In one example, the access point to the core network may transmit an indication to the one or more wireless communication devices that the emergency information is available using an access network query protocol (ANQP) protocol.

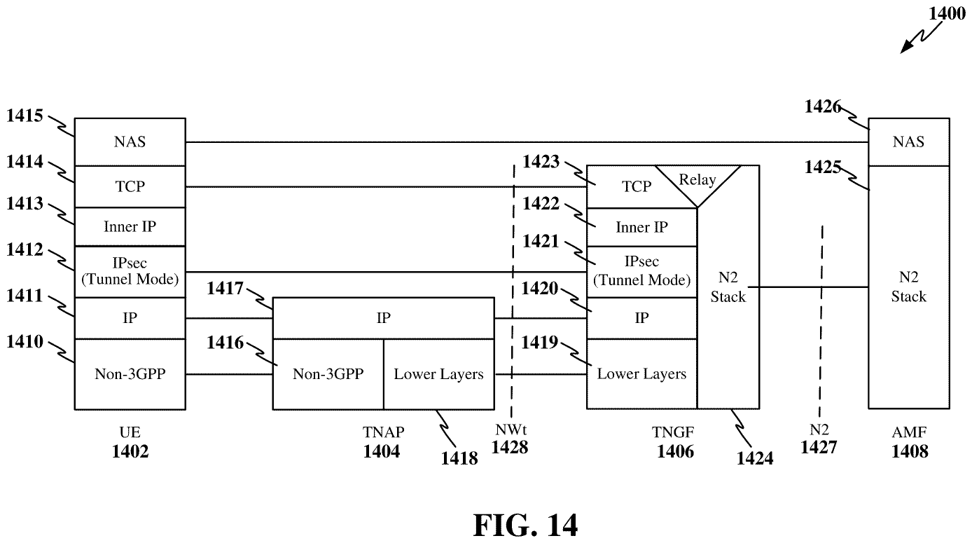

FIG. 14 is a block diagram representation of protocol stacks 1400 of a wireless communication device (UE 1402), a Trusted Non-3GPP Access Point (TNAP 1404), a Trusted Non-3GPP Gateway Function (TNGF 1406), and an access and mobility management function (AMF 1408) implementing PWS over WLAN according to some aspects of the disclosure. The functions, entities, and elements represented in the protocol stacks 1400 may correspond to like-named functions, entities, and elements in the 5GS PWS architecture 800 of FIG. 8 and the call flow diagram 900 of FIG. 9. The UE 1402 protocol stack includes a non-3GPP layer 1410 below an Internet protocol (IP) layer 1411, below an IP_{sec} layer 1412, below an inner IP layer 1413, below a transmission control protocol (TCP) layer 1414, and below an NAS layer 1415. The TNAP 1404 protocol stack includes a non-3gpp layer 1416 corresponding to the non-3GPP layer 1410 of the UE 1402. Above the non-3GPP layer 1416 is an IP layer 1417 corresponding to the IP layer 1411 of the UE 1402. Lower layers 1418 at the level of the non-3GPP layer 1416 of the TNAP 1404 correspond to lower layers 1419 of the TNGF 1406. Above the lower layers 1419 of the TNGF 1406 is an IP layer 1420 corresponding to the IP layer 1417 of the TNAP 1404. Above the IP layer 1420 is an IP_{sec} layer 1421 corresponding to the IP_{sec} layer 1412 of the UE 1402. Above the IP_{sec} layer 1421 is an inner IP layer 1422. Above the Inner IP layer 1422 is a TCP layer 1423 corresponding to the TCP layer 1414 of the UE. 1402. The TNGF 1406 protocol stack includes an N2 stack 1424 corresponding to the N2 stack of the AMF 1408. The N2 reference point 1427 is depicted between the AMF 1408 and the TNGF 1406. Also depicted between the TNGF 1406 and the UE 1402 is the NWt reference point 1428.

Of course, in the above examples, the circuitry included in the processor 1004 of FIG. 10 and/or the processor 1204 of FIG. 12 is merely provided as an example. Other means for carrying out the described processes or functions may be included within various aspects of the present disclosure, including but not limited to the instructions stored in the computer-readable medium 1006 of FIG. 10 and/or the computer-readable medium 1206 of FIG. 12, or any other suitable apparatus or means described in any one of the FIGS. 1-3 and 5-14 and utilizing, for example, the processes and/or algorithms described herein in relation to FIGS. 8, 9, 11, 12, and/or 14.

The following provides an overview of aspects of the present disclosure:
Aspect 1: A method, operational at a wireless communication device, comprising: performing a registration procedure with a public land mobile network (PLMN) via a wireless local area network (WLAN); obtaining PLMN services over the WLAN subsequent to performing the registration procedure, the PLMN services including at least a public warning service; receiving a public warning service notification via the public warning service; and retrieving public warning service information from the PLMN via the WLAN in response to receiving the public warning service notification.

Aspect 2: The method of aspect 1, wherein the wireless communication device is preconfigured to perform the registration procedure via the WLAN to obtain the public warning service.

Aspect 3: The method of aspect 1 or 2, further comprising: determining that the wireless communication device is not registered with the PLMN; and performing the registration procedure in response to the determining.

Aspect 4: The method of any of aspects 1 through 3, wherein the public warning service notification is one of: a primary public warning service notification, a secondary public warning service notification, or both the primary public warning service notification and the secondary public warning service notification.

Aspect 5: The method of any of aspects 1 through 4, wherein the public warning service notification indicates that the public warning service information is available from the PLMN via the WLAN.

Aspect 6: The method of any of aspects 1 through 5, further comprising: initiating an access network query protocol (ANQP) procedure in support of the retrieving the public warning service information from the PLMN via the WLAN.

Aspect 7: The method of any of aspects 1 through 6, further comprising: retrieving the public warning service information utilizing an access network query protocol (ANQP) procedure, wherein the public warning service information is one of: a primary public warning service notification, a secondary public warning service notification, or both the primary public warning service notification and the secondary public warning service notification.

Aspect 8: The method of any of aspects 1 through 7, further comprising: receiving the public warning service notification in a non-access stratum (NAS) message while the wireless communication device is in a connected mode.

Aspect 9: The method of aspect 8, wherein the NAS message is a NAS NOTIFICATION message.

Aspect 10: A wireless communication device, comprising: one or more memories; and one or more processors being configured to, based at least in part on information stored in the one or memories: perform a registration procedure with a public land mobile network (PLMN) via a wireless local area network (WLAN); obtain PLMN services over the WLAN subsequent to performing the registration procedure, the PLMN services including at least a public warning service; receive a public warning service notification via the public warning service; and retrieve public warning service information from the PLMN via the WLAN in response to receiving the public warning service notification.

Aspect 11: The wireless communication device of aspect 10, wherein the one or more processors are preconfigured to perform the registration procedure via the WLAN to obtain the public warning service.

Aspect 12: The wireless communication device of aspect 10 or 11, wherein the one or more processors are further configured to: determine that the wireless communication device is not registered with the PLMN; and perform the registration procedure in response to the determining.

Aspect 13: The wireless communication device of any of aspects 10 through 12, wherein the public warning service notification is one of: a primary public warning service notification, a secondary public warning service notification, or both the primary public warning service notification and the secondary public warning service notification.

Aspect 14: The wireless communication device of any of aspects 10 through 13, wherein the public warning service notification indicates that the public warning service information is available from the PLMN via the WLAN.

Aspect 15: The wireless communication device of any of aspects 10 through 14, wherein the one or more processors are further configured to: initiate an access network query protocol (ANQP) procedure in support of the retrieving the public warning service information from the PLMN via the WLAN.

Aspect 16: The wireless communication device of any of aspects 10 through 15, wherein the one or more processors are further configured to: retrieve the public warning service information utilizing an access network query protocol (ANQP) procedure, wherein the public warning service information is one of: a primary public warning service notification, a secondary public warning service notification, or both the primary public warning service notification and the secondary public warning service notification.

Aspect 17: The wireless communication device of any of aspects 10 through 16, wherein the one or more processors are further configured to: receive the public warning service notification in a non-access stratum (NAS) message while the wireless communication device is in a connected mode.

Aspect 18: The wireless communication device of aspect 17, wherein the NAS message is a NAS NOTIFICATION message.

Aspect 19: A method, operational at an access point to a core network of a wireless communication network, comprising: receiving emergency information associated with a public warning service; and transmitting the emergency information to one or more wireless communication devices registered with the wireless communication network via a wireless local area network (WLAN).

Aspect 20: The method of aspect 19, wherein the access point to the core network is an access and mobility management function (AMF).

Aspect 21: The method of aspect 19, wherein the WLAN is accessed by the one or more communication devices at a trusted non-3GPP access point.

Aspect 22: The method of aspect 19 or 21, further comprising: receiving the emergency information from a cell broadcast center (CBC).

Aspect 23: The method of any of aspects 19 through 22, further comprising: transmitting the emergency information via the WLAN only to those of the one or more wireless communication devices that are registered with the wireless communication network for access exclusively via the WLAN.

Aspect 24: The method of any of aspects 19 through 23, further comprising: transmitting the emergency information using a non-access stratum (NAS) protocol Notification message.

Aspect 25: The method of any of aspects 19 through 24, wherein the emergency information includes a target area.

Aspect 26: The method of aspect 25, further comprising: transmitting the emergency information to a WLAN-3GPP gateway in the target area.

Aspect 27: The method of aspect 25, further comprising: transmitting the emergency information to a WLAN access point in the target area via a WLAN-3GPP gateway.

Aspect 28: The method of any of aspects 19 through 26, wherein the transmitting the emergency information further comprises: transmitting an indication to the one or more wireless communication devices that the emergency information is available using an access network query protocol (ANQP) protocol.

As used herein, the term “determine” or “determining” encompasses a wide variety of actions and, therefore, “determining” can include calculating, computing, processing, deriving, investigating, looking up (such as via looking up in a table, a database, or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Similarly, a phrase referring to A and/or B may include A only, B only, or a combination of A and B.

As used herein, “based on” is intended to be interpreted in the inclusive sense, unless otherwise explicitly indicated. For example, “based on” may be used interchangeably with “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A method, operational at a wireless communication device, comprising:
performing a registration procedure with a public land mobile network (PLMN) via a wireless local area network (WLAN);
obtaining PLMN services over the WLAN subsequent to performing the registration procedure, the PLMN services including at least a public warning service;
receiving a public warning service notification via the public warning service; and
retrieving public warning service information from the PLMN via the WLAN in response to receiving the public warning service notification.

2. The method of claim 1, wherein the wireless communication device is preconfigured to perform the registration procedure via the WLAN to obtain the public warning service.

3. The method of claim 1, further comprising:
determining that the wireless communication device is not registered with the PLMN; and
performing the registration procedure in response to the determining.

4. The method of claim 1, wherein the public warning service notification is one of:
a primary public warning service notification,
a secondary public warning service notification, or
both the primary public warning service notification and the secondary public warning service notification.

5. The method of claim 1, wherein the public warning service notification indicates that the public warning service information is available from the PLMN via the WLAN.

6. The method of claim 1, further comprising:
initiating an access network query protocol (ANQP) procedure in support of the retrieving the public warning service information from the PLMN via the WLAN.

7. The method of claim 1, further comprising:
retrieving the public warning service information utilizing an access network query protocol (ANQP) procedure, wherein the public warning service information is one of:
a primary public warning service notification,
a secondary public warning service notification, or
both the primary public warning service notification and the secondary public warning service notification.

8. The method of claim 1, further comprising:
receiving the public warning service notification in a non-access stratum (NAS) message while the wireless communication device is in a connected mode.

9. The method of claim 8, wherein the NAS message is a NAS NOTIFICATION message.

10. A wireless communication device, comprising:
one or more memories; and
one or more processors being configured to, based at least in part on information stored in the one or memories:
perform a registration procedure with a public land mobile network (PLMN) via a wireless local area network (WLAN);
obtain PLMN services over the WLAN subsequent to performing the registration procedure, the PLMN services including at least a public warning service;
receive a public warning service notification via the public warning service; and
retrieve public warning service information from the PLMN via the WLAN in response to receiving the public warning service notification.

11. The wireless communication device of claim 10, wherein the one or more processors are preconfigured to perform the registration procedure via the WLAN to obtain the public warning service.

12. The wireless communication device of claim 10, wherein the one or more processors are further configured to:
determine that the wireless communication device is not registered with the PLMN; and perform the registration procedure in response to the determining.

13. The wireless communication device of claim 10, wherein the public warning service notification is one of:
a primary public warning service notification,
a secondary public warning service notification, or
both the primary public warning service notification and the secondary public warning service notification.

14. The wireless communication device of claim 10, wherein the public warning service notification indicates that the public warning service information is available from the PLMN via the WLAN.

15. The wireless communication device of claim 10, wherein the one or more processors are further configured to:
initiate an access network query protocol (ANQP) procedure in support of the retrieving the public warning service information from the PLMN via the WLAN.

16. The wireless communication device of claim 10, wherein the one or more processors are further configured to:
retrieve the public warning service information utilizing an access network query protocol (ANQP) procedure, wherein the public warning service information is one of:
a primary public warning service notification,
a secondary public warning service notification, or
both the primary public warning service notification and the secondary public warning service notification.

17. The wireless communication device of claim 10, wherein the one or more processors are further configured to:
receive the public warning service notification in a non-access stratum (NAS) message while the wireless communication device is in a connected mode.

18. The wireless communication device of claim 17, wherein the NAS message is a NAS NOTIFICATION message.

19. A method, operational at an access point to a core network of a wireless communication network, comprising:
receiving emergency information associated with a public warning service; and
transmitting the emergency information to one or more wireless communication devices registered with the wireless communication network via a wireless local area network (WLAN).

20. The method of claim 19, wherein the access point to the core network is an access and mobility management function (AMF).

21-30. (canceled)
